(19) United States
(12) Patent Application Publication
(10) Pub. No.: US 2024/0394429 A1
(43) Pub. Date: Nov. 28, 2024

(54) OPTIMIZING A MANUFACTURING PROCESS OF A PHYSICAL PRODUCT USING A VIRTUAL ENVIRONMENT

(71) Applicant: International Business Machines Corporation, Armonk, NY (US)

(72) Inventors: Perla Guadalupe Reyes Ramirez, Zapopan (MX); Silvia Cristina Santa Ana Velasco, Guadalajara (MX); Carolina Garcia Delgado, Zapopan (MX); Paul Llamas Virgen, Guadalajara (MX); Scott E. Schneider, Rolesville, NC (US)

(21) Appl. No.: 18/201,732

(22) Filed: May 24, 2023

(51) Int. Cl. G06F 30/20; G06F 3/01; G06F 30/17

(52) U.S. Cl. CPC G06F 30/20; G06F 3/016; G06F 30/17; G06F 2119/18

(57) ABSTRACT

A computer-implemented method, system and computer program product for optimizing a manufacturing process of a physical product using a virtual environment. A representative sample as a digital representation for each batch of components to be assembled into the physical product is generated based on component batch data. A digital twin simulation in a virtual environment using the digital representation for each batch of components is then created and executed to determine potential defects in assembling components into the physical product prior to actually assembling the components into the physical product. An analysis is performed in the simulation to determine whether any combination of components to be assembled into the physical product has been identified as failing to meet a predetermined tolerance range thereby identifying a potential defect in assembling the physical product. Upon identifying a potential defect, an alert is generated indicating a potential defect in assembling the physical product.

### TECHNICAL FIELD

The present disclosure relates generally to the manufacturing process, and more particularly to optimizing the manufacturing process of a physical product using a virtual environment.

### BACKGROUND

A manufacturing process uses manufacturing methods, operations scheduling software, machinery, and labor to transform raw material into the finished product, including composite products. A composite product is a product formed from multiple components or parts, often sourced from disparate providers.

### SUMMARY

In one embodiment of the present disclosure, a computer-implemented method for optimizing a manufacturing process of a physical product using a virtual environment comprises receiving component batch data regarding batches of components to be assembled into the physical product. The method further comprises generating a representative sample as a digital representation for each batch of components to be used in the virtual environment based on the component batch data. The method additionally comprises creating and executing a digital twin simulation in the virtual environment using the digital representation for each batch of components. Furthermore, the method comprises generating an alert indicating a potential defect in assembling the physical product in response to identifying a combination of components to be assembled into the physical product that fails to meet a predetermined tolerance range based on the digital twin simulation.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the manufacturing process optimizer for optimizing the manufacturing process of a physical product using a virtual environment in accordance with an embodiment of the present disclosure;

FIGS. 3A-3B illustrate the component batch data provided by disparate suppliers for multiple components to be assembled into a physical product in accordance with an embodiment of the present disclosure;

FIGS. 4A-4B illustrate a further example of the component batch data provided by disparate suppliers for multiple components to be assembled into a physical product in accordance with an embodiment of the present disclosure.

FIG. 5 illustrates an embodiment of the hardware configuration of the manufacturing process optimizer which is representative of a hardware environment for practicing the present disclosure;

FIG. 6 is a flowchart of a method for optimizing the manufacturing process of a physical product using a virtual environment in accordance with an embodiment of the present disclosure; and

FIG. 7 is a flowchart of a method for allowing a user to interact with the digital twin simulation in accordance with an embodiment of the present disclosure.

### DETAILED DESCRIPTION

As stated above, a manufacturing process uses manufacturing methods, operations scheduling software, machinery, and labor to transform raw material into the finished product, including composite products. A composite product is a product formed from multiple components or parts, often sourced from disparate providers.

The components that are assembled into the composite product (or a larger component of the composite product) are frequently shipped to the industrial facility (e.g., factory, manufacturing plant, production plant, etc.) where such a manufacturing process is implemented without compatibility, tolerance or cosmetic quality verification. Compatibility refers to such components being able to be integrated together to form the composite product (or a larger component of the composite product). Tolerance refers to the maximum variance in the dimensions of the components where such components can still be assembled together to form the composite product (or a larger component of the composite product) properly. Cosmetic quality verification refers to verifying that the features of the components have the correct specifications.

By not performing such compatibility, tolerance or cosmetic quality verification of the components prior to shipping such components to the industrial facility, such verification is performed on-site at the industrial facility when the physical parts are available. As a result, defects in the assembled product, such as a composite product, may not be noticed until the product is actually assembled, which results in additional costs in redesigning the product as well as causing supply chain delays.

For example, the three separate components of an enclosure, a duel in-line memory module (DIMM), and a DIMM slot are assembled to form a cavity of a final product. Each component has the correct dimensions according to the specifications. However, when such components are integrated (assembled) to form a cavity of the final product, a quality problem results in which a pin on the DIMM slot becomes bent. Such a pin on the DIMM slot becomes bent because the thickness of the integrated components is 0.92 mm which exceeds the allotted dimension of 0.82 mm for the cavity.

If, however, such defects were detected prior to the assembling of the components into the final product (or a larger component of the final product), then the additional costs in redesigning the product and supply chain delays could potentially be avoided.

The embodiments of the present disclosure provide a means for detecting potential defects prior to the assembling of the components into a final product (or a larger component of the final product) by generating a representative sample (in digital or virtual form so as to form a digital representation) for each batch of components to be assembled into the physical product. A “physical product,” as used herein, refers to a tangible manufactured article that was formed by assembling multiple components or parts. A “component,” as used herein, refers to the element or part of the physical product. In one embodiment, such a physical product is the “final product,” which refers to the end product in the manufacturing process. In one embodiment, such a physical product is a component of the final product, where the component of the final product is comprised of multiple components used to assemble the component of the final product. In one embodiment, the representative sample (in digital or virtual form) for each batch of components to be assembled into the physical product is generated based on component batch data, which includes statistical data, assembly data, dimensional data, test data, and/or characteristic data. A digital twin simulation is then created and executed in a virtual environment using the digital representation for each batch of components to be assembled into the physical product in order to identify potential defects in assembling the components into the physical product based on the component batch data. Upon identifying a combination of components to be assembled into the physical product that fails to meet a predetermined tolerance range based on the digital twin simulation, an alert is generated indicating a potential defect in assembling the physical product. A further discussion regarding these and other features is provided below.

In some embodiments of the present disclosure, the present disclosure comprises a computer-implemented method, system and computer program product for optimizing a manufacturing process of a physical product using a virtual environment. In one embodiment of the present disclosure, component batch data for the batches of components to be assembled into the physical product are received from one or more suppliers. A “batch of components,” as used herein, refers to a collection or group of components. “Component batch data,” as used herein, refers to data pertaining to batches of components, such as statistical data, assembly data, dimensional data, test data, and/or characteristic data. A representative sample as a digital or virtual representation for each batch of components to be used in the virtual environment based on the component batch data is generated. For example, using statistical data of the component batch data, such as the maximum or minimum length of the components in the batch of components, a representative sample (in the form of a digital or virtual representation) of the entire batch of components may be utilized to represent the entire component batch from the supplier rather than digitizing each component of the batch of components, which is extremely time-consuming. A digital twin simulation in the virtual environment using the digital or virtual representation for each batch of components is then created and executed to determine potential defects in assembling components into the physical product prior to actually assembling the components into the physical product based on the component batch data. A “digital twin simulation,” as used herein, is a simulation of the virtual representation of a real-world physical asset of a system, such as the components of a composite product, which is continuously updated. An analysis is performed in the digital twin simulation to discover any potential defects in assembling components into the physical product based on analyzing the interconnections involving the integration of such components to form the physical product. Such an analysis involves determining whether any combination of components to be assembled into the physical product has been identified as failing to meet a predetermined tolerance range thereby identifying a potential defect in assembling the physical product. Upon identifying a combination of components to be assembled into the physical product as failing to meet the predetermined tolerance range, an alert is generated indicating a potential defect in assembling the physical product. In this manner, the manufacturing process of a physical product may be optimized using a virtual environment by detecting potential defects prior to assembling the components into the physical product thereby preventing redesigns of the physical product and avoiding supply chain delays.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

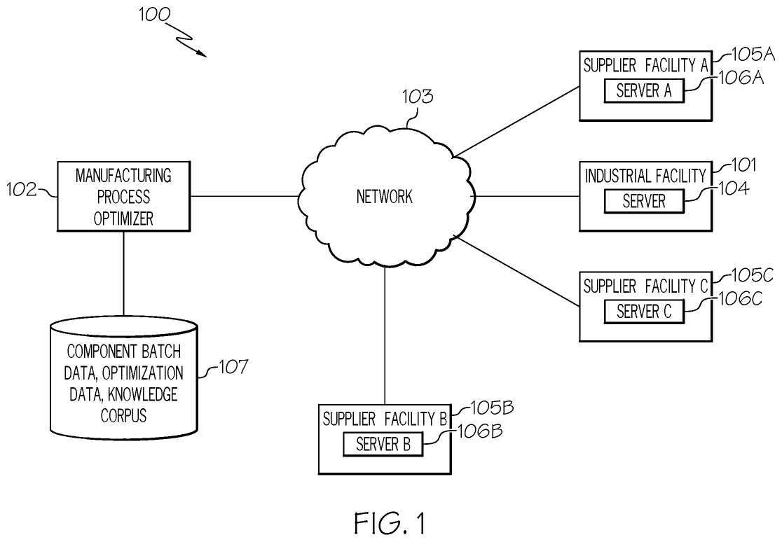

Referring now to the Figures in detail, FIG. 1 illustrates an embodiment of the present disclosure of a communication system 100 for practicing the principles of the present disclosure. Communication system 100 includes an industrial facility 101 connected to a manufacturing process optimizer 102 via a network 103.

An “industrial facility” 101, as used herein, refers to a complex (e.g., manufacturing plant) which may consist of one or more buildings used for manufacturing a physical product. In one embodiment, industrial facility 101 implements a manufacturing process for assembling physical products, such as composite products, from multiple components sourced from disparate providers (referred to as “suppliers”). As discussed above, a “physical product,” as used herein, refers to a tangible manufactured article that was formed by assembling multiple components or parts. A “component,” as used herein, refers to the element or part of the physical product. In one embodiment, such a physical product is the “final product,” which refers to the end product in the manufacturing process. In one embodiment, such a physical product is a component of the final product, where the component of the final product is comprised of multiple components used to assemble the component of the final product.

In the illustration of FIG. 1, the interconnection of industrial facility 101 to manufacturing process optimizer 102 via network 103 is accomplished via a server 104 of industrial facility 101. In one embodiment, server 104 stores component batch data received from one or more suppliers regarding the batches of components to be assembled into the physical product. In one embodiment, suppliers provide the components to be assembled into the physical product in batches, such as a group or collection of the components. For example, one supplier may provide a batch of 99 dual in-line memory modules (DIMMs), a second supplier may provide a batch of 99 DIMM slots and a third supplier may provide a batch of 99 enclosures which are together assembled into 99 physical products.

A “batch of components,” as used herein, refers to a collection or group of components. “Component batch data,” as used herein, refers to data pertaining to batches of components, such as statistical data, assembly data, dimensional data, test data, and/or characteristic data. Statistical data, as used herein, refers to the statistical measurements performed on the batch of components, such as the mean, median, or mode of quantitative data (e.g., size, shape, etc.) pertaining to such components. For example, the statistical data may include the mean of the maximum and minimum length. Assembly data, as used herein, refers to the data pertaining to the integration of the components to form the physical product. For example, such assembly data may indicate which part can be integrated into which other parts satisfactorily. For instance, assembly data may indicate that the 100×118 mm ABS® speaker port tube bass reflex tube can be integrated into the Dayton Audio® 2k-HPF-4 high pass speaker crossover. Dimensional data, as used herein, refers to the data pertaining to the features of the components, such as the length, depth, height, width, etc. Test data, as used herein, refers to the data created or selected to satisfy the execution preconditions and inputs to execute one or more test cases. Examples of such test data include temperature versus time, acoustic emission versus time, corrosion damage, mechanical damage, metallurgical properties, etc. Characteristic data, as used herein, refers to features and qualities of the components, such as the operating conditions, construction materials, information on the contents, etc.

As discussed above, in one embodiment, server 104 of industrial facility 101 receives component batch data from disparate suppliers. In one embodiment, the component batch data is stored in a storage device of server 104. In one embodiment, manufacturing process optimizer 102 receives such stored component batch data from server 104, such as via network 103.

Furthermore, as shown in FIG. 1, supplier facilities 105A-105C (identified as “Supplier Facility A,” “Supplier Facility B,” and “Supplier Facility C,” respectively, in FIG. 1) are connected to network 103. Supplier facilities 105A-105C may collectively or individually be referred to as supplier facilities 105 or supplier facility 105, respectively. A “supplier facility” 105, as used herein, refers to a complex which may consist of one or more buildings used for manufacturing a component to be integrated with another component(s) to form a physical product. A “supplier,” as used herein, refers to the organization that provides such components using the supplier facility.

In the illustration of FIG. 1, the interconnection of supplier facility 105A-105C to manufacturing process optimizer 102 via network 103 is accomplished via a server 106A-106C, respectively. Servers 106A-106C (identified as “Server A,” “Server B,” and “Server C,” respectively in FIG. 1) may collectively or individually be referred to as servers 106 or server 106, respectively.

In one embodiment, server 106 stores component batch data pertaining to the batches of components manufactured by supplier facility 105, such as in a storage device of server 106.

In one embodiment, servers 106 of supplier facilities 105 provide the component batch data pertaining to the batch(es) of components to be shipped to industrial facility 101 to be assembled into the physical product directly to manufacturing process optimizer 102, such as via network 103. Such component batch data is stored in a database 107 connected to manufacturing process optimizer 102.

In one embodiment, manufacturing process optimizer 102 is configured to optimize the manufacturing process of a physical product by detecting potential defects prior to the assembling of the components into a final product (or a larger component of the final product) using a virtual environment. In one embodiment, manufacturing process optimizer 102 receives component batch data from one or more suppliers regarding the batches of components to be assembled into a physical product. In one embodiment, such component batch data is directly provided to manufacturing process optimizer 102 from server 106 of the supplier. Alternatively, such component batch data is provided to manufacturing process optimizer 102 from server 104 of industrial facility 101. Such component batch data is stored in database 107 connected to manufacturing process optimizer 102.

In one embodiment, manufacturing process optimizer 102 generates a representative sample, such as in the form of a digital representation, for each batch of components to be used in a virtual environment based on the component batch data. For example, using statistical data of the component batch data, such as the maximum or minimum length of the components in the batch of components, a representative sample (in the form of a digital representation) of the entire batch of components may be utilized to represent the entire component batch from the supplier rather than digitizing each component of the batch of components, which is extremely time-consuming. As discussed further below, each representative sample, for each batch of components that is to be assembled into the physical product, will be used in the virtual environment to discover any potential defects prior to the assembling of the components into the final product (or a larger component of the final product).

In one embodiment, manufacturing process optimizer 102 is configured to create and execute a digital twin simulation in a virtual environment using the digital representation for each batch of components to determine potential defects in assembling components to form the physical product based on the composite batch data. In one embodiment, such a digital twin simulation forms optimization data. “Optimization data,” as used herein, refers to statistical data, assembly data, dimensional data, test data, and/or characteristic data used to quantify the compatibility between the physical component batches. In one embodiment, such optimization data is stored in database 107.

A “digital twin simulation,” as used herein, is a simulation of the virtual representation of a real-world physical asset of a system, such as the components of a composite product, which is continuously updated.

In one embodiment, manufacturing process optimizer 102 identifies potential defects in assembling components into the physical product based on predetermined tolerance ranges involving combinations of the components that are used to assemble the physical product. A “tolerance range,” as used herein, refers to the statistical boundaries that represent the range of outcomes for a given process. For example, a tolerance range may correspond to a thickness dimension (e.g., maximum thickness of 0.82 mm and a minimum thickness of 0.75 mm) for the physical product that was assembled based on integrating three separate components to form the physical product.

In one embodiment, manufacturing process optimizer 102 identifies potential defects in assembling components to form the physical product based on identifying a combination of components to be assembled into the physical product that fails to meet a predetermined tolerance range. When such a situation is identified, a potential defect in assembling the physical product is said to occur.

In one embodiment, manufacturing process optimizer 102 generates an alert in response to identifying a potential defect in assembling the physical product.

In one embodiment, manufacturing process optimizer 102 enables a user, such as the user of manufacturing process optimizer 102, to interact with the digital representation for each batch of components in a virtual environment, such as the virtual environment of the digital twin simulation, to virtually assemble at least a portion of the digital product representation of the physical product.

In one embodiment, manufacturing process optimizer 102 guides a user through a virtual assembly interaction using component batch data and optimization data from the digital twin simulation to identify a combination(s) of components to be assembled into the physical product with a tolerance outside the predetermined tolerance range. In one embodiment, such guidance is provided in response to generating an alert in identifying a potential defect in assembling the physical product.

In one embodiment, in connection with guiding the user through the virtual assembly process, such guidance may include providing haptic feedback to the user. For example, in one embodiment, manufacturing process optimizer 102 provides haptic feedback (e.g., vibration, heat, pressure, etc.) once the user is viewing the combination of the components in the virtual environment that results in a potential defect in assembling the physical product. That is, manufacturing process optimizer 102 provides haptic feedback once the user is guided to visualize the source of a potential defect in assembling the physical product.

In one embodiment, manufacturing process optimizer 102 generates a recommendation for addressing the potential defect, such as by utilizing a knowledge corpus stored in database 107. A “knowledge corpus,” as used herein, refers to a collection of data that contains information pertaining to particular defects in assembling physical products and the solutions of such defects. In one embodiment, such a knowledge corpus is stored in database 107.

In this manner, the manufacturing process of a physical product may be optimized using a virtual environment by detecting potential defects and potentially addressing such potential defects prior to assembling the components into the physical product. A further discussion regarding these and other features is provided below.

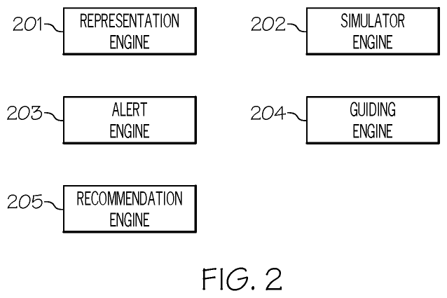

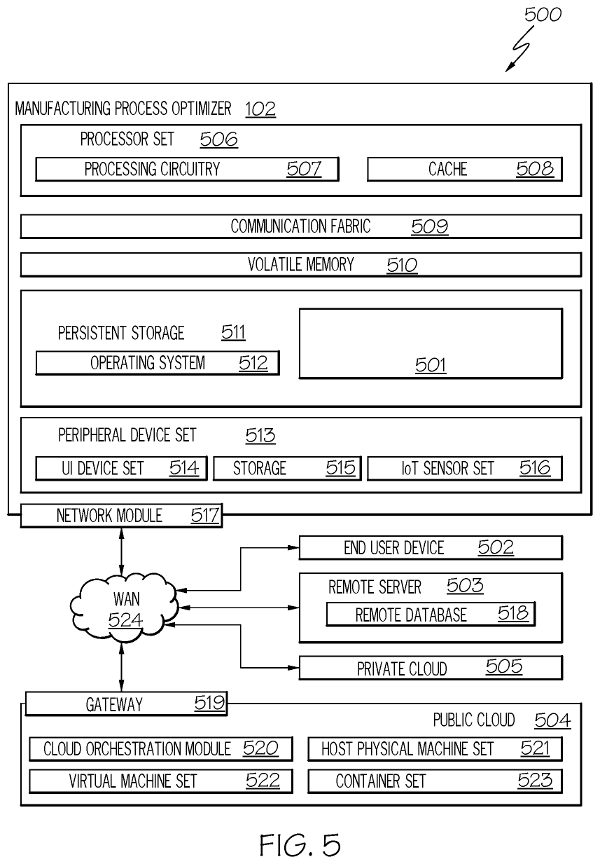

A description of the software components of manufacturing process optimizer 102 used for optimizing the manufacturing process of a physical product using a virtual environment is provided below in connection with FIG. 2. A description of the hardware configuration of manufacturing process optimizer 102 is provided further below in connection with FIG. 5.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of industrial facilities 101, manufacturing process optimizers 102, networks 103, servers 104, supplier facilities 105, servers 106 and databases 107.

A discussion regarding the software components used by manufacturing process optimizer 102 for optimizing the manufacturing process of a physical product using a virtual environment is provided below in connection with FIG. 2.

FIG. 2 is a diagram of the software components used by manufacturing process optimizer 102 for optimizing the manufacturing process of a physical product using a virtual environment in accordance with an embodiment of the present disclosure.

Referring to FIG. 2, in conjunction with FIG. 1, manufacturing process optimizer 102 includes a representation engine 201 configured to receive component batch data from one or more suppliers regarding the batches of components to be assembled into a physical product. In one embodiment, such component batch data is directly provided to representation engine 201 from server 106 of the supplier(s). Alternatively, such component batch data is provided to representation engine 201 from server 104 of industrial facility 101. Such component batch data is stored in database 107 connected to manufacturing process optimizer 102.

As discussed above, in one embodiment, suppliers provide the components to be assembled into the physical product in batches, such as a group or collection of the components. For example, one supplier may provide a batch of 99 dual in-line memory modules (DIMMs), a second supplier may provide a batch of 99 DIMM slots and a third supplier may provide a batch of 99 enclosures which are together assembled into 99 physical products.

A “batch of components,” as used herein, refers to a collection or group of components. “Component batch data,” as used herein, refers to data pertaining to batches of components, such as statistical data, assembly data, dimensional data, test data, and/or characteristic data. Statistical data, as used herein, refers to the statistical measurements performed on the batch of components, such as the mean, median, or mode of quantitative data (e.g., size, shape, etc.) pertaining to such components. For example, the statistical data may include the mean of the maximum and minimum length. Assembly data, as used herein, refers to the data pertaining to the integration of the components to form the physical product. For example, such assembly data may indicate which part can be integrated into which other parts satisfactorily. For instance, assembly data may indicate that the 100×118 mm ABS® speaker port tube bass reflex tube can be integrated into the Dayton Audio® 2k-HPF-4 high pass speaker crossover. Dimensional data, as used herein, refers to the data pertaining to the features of the components, such as the length, depth, height, width, etc. Test data, as used herein, refers to the data created or selected to satisfy the execution preconditions and inputs to execute one or more test cases. Examples of such test data include temperature versus time, acoustic emission versus time, corrosion damage, mechanical damage, metallurgical properties, etc. Characteristic data, as used herein, refers to features and qualities of the components, such as the operating conditions, construction materials, information on the contents, etc.

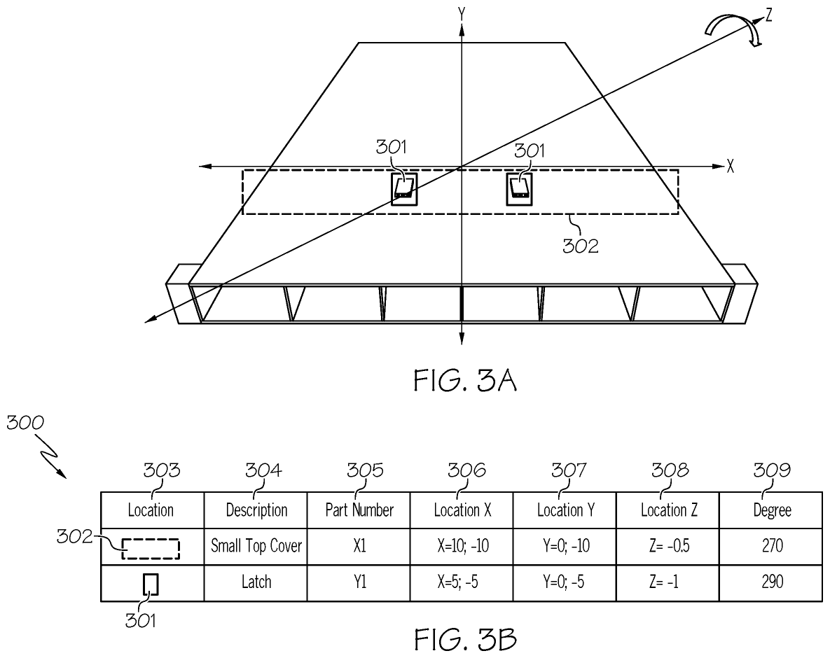

An example of the component batch data including dimensional data is illustrated in FIGS. 3A-3B. Referring to FIGS. 3A-3B, FIGS. 3A-3B illustrate the component batch data provided by disparate suppliers for multiple components to be assembled into a physical product in accordance with an embodiment of the present disclosure.

As shown in FIG. 3A, FIG. 3A depicts the location of latches 301 to be integrated with a small top cover 302 forming the physical product. As illustrated in FIG. 3B, FIG. 3B is a table 300 indicating the component batch data for the components 302, 301 depicted in FIG. 3A. In one embodiment, such component batch data includes a location 303, a description 304 (e.g., small top cover, latch), a part number 305 (e.g., X1, Y1), a location along the X-axis 306 (e.g., X=10; −10 and X=5; −5), a location along the Y-axis 307 (e.g., Y=0; −10 and Y=0; −5), a location along the Z-axis 308 (e.g., Z=−0.5 and Z=−1) and the degree 309 corresponding to the measurement of the angle formed by component 302, 301 with respect to the center axis (e.g., 270°, 290°).

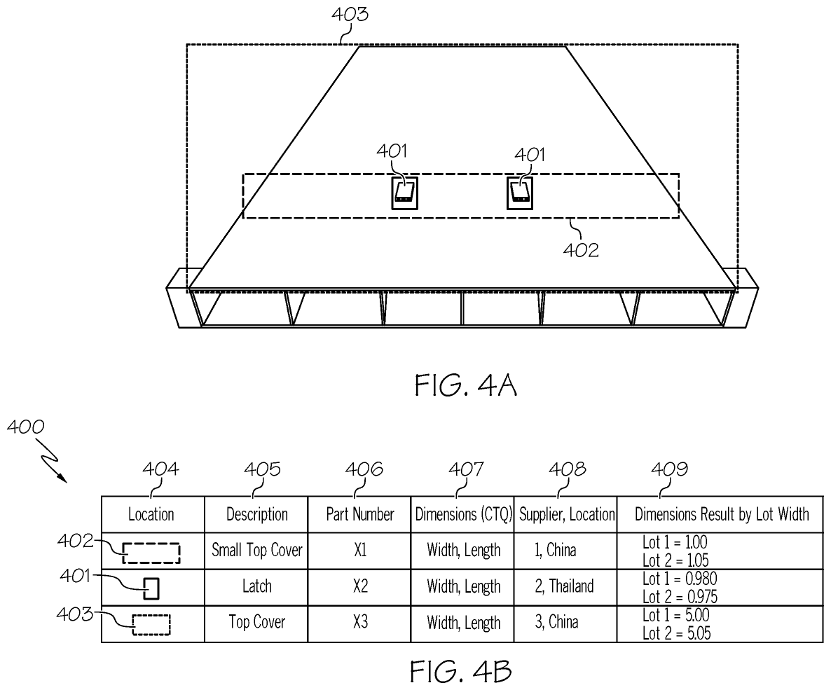

Another example of the component batch data including dimensional data is illustrated in FIGS. 4A-4B. Referring to FIGS. 4A-4B, FIGS. 4A-4B illustrate a further example of the component batch data provided by disparate suppliers for multiple components to be assembled into a physical product in accordance with an embodiment of the present disclosure.

As shown in FIG. 4A, FIG. 4A depicts the location of latches 401 to be integrated with a small top cover 402 and a top cover 403 forming the physical product. As illustrated in FIG. 4B, FIG. 4B is a table 400 indicating the component batch data for the components 402, 401, 403 depicted in FIG. 4A. In one embodiment, such component batch data includes a location 404, a description 405 (e.g., small top cover, latch, top cover), a part number 406 (e.g., X1, X2, X3), critical to quality (CTQ) dimensions 407 (e.g., width, length), the supplier and the location of the supplier (see element number 408) (e.g., supplier #1 located in China, supplier #2 located in Thailand and supplier #3 located in China) and the average dimension (width) 409 per lot or batch of components for each of the components (parts) (e.g., Lot 1=1.00 and Lot 2=1.05 for Part Number X1; Lot 1=0.980 and Lot 2=0.975 for Part Number X2; and Lot 1=5.00 and Lot 2=5.05 for Part Number X3).

Returning to FIG. 2, as discussed above, in one embodiment, server 104 of industrial facility 101 receives component batch data from disparate suppliers. In one embodiment, the component batch data is stored in a storage device of server 104. In one embodiment, representation engine 201 receives such stored component batch data from server 104, such as via network 103.

Furthermore, in one embodiment, server 106 of supplier facility 105 stores component batch data pertaining to the batches of components manufactured by supplier facility 105, such as in a storage device of server 106.

In one embodiment, servers 106 of supplier facilities 105 provide the component batch data pertaining to the batches of components to be shipped to industrial facility 101 to be assembled into the physical product directly to representation engine 201, such as via network 103. Such component batch data is stored in database 107 connected to manufacturing process optimizer 102.

Furthermore, in one embodiment, representation engine 201 is configured to generate a representative sample as a digital or virtual representation for each batch of components to be used in the virtual environment based on the component batch data. For example, using statistical data of the component batch data, such as the maximum or minimum length of the components in the batch of components, a representative sample (in the form of a digital or virtual representation) of the entire batch of components may be utilized to represent the entire component batch from the supplier rather than digitizing each component of the batch of components, which is extremely time-consuming. As discussed further below, each representative sample, for each batch of components that is to be assembled into the physical product, will be used in the virtual environment to discover any potential defects prior to the assembling of the components into the final product (or a larger component of the final product).

In one embodiment, representation engine 201 creates a digital twin of the representative sample for each batch of components. A “digital twin,” as used herein, is a digital or virtual representation (e.g., virtual model) of a real-world physical asset of a system, such as the component to be used in conjunction with another component(s) to be integrated together to form the physical product. In one embodiment, such a digital twin is created based on the component batch data, which includes statistical data, assembly data, dimensional data, test data, and/or characteristic data. Using such data, such as the maximum and minimum length, age, size, shape, construction materials, coating history, information on the contents, test data (e.g., temperature versus time, corrosion damage, mechanical damage, metallurgical properties), operating conditions, integration data (e.g., component A is to be integrated in the left-hand slot of component B), etc., a digital twin is created with such features.

In one embodiment, representation engine 201 utilizes various software tools for creating and executing such a digital twin, including, but not limited to, Vention®, aPriori® Autodesk® Digital Twin, XMPro®, Predix®, Ansys® Twin Builder, 7bridges, Akka®, Abaqus®, etc.

Manufacturing process optimizer 102 further includes a simulator engine 202 configured to create and execute a digital twin simulation in the virtual environment using the digital or virtual representation for each batch of components to identify potential defects in assembling components into the physical product prior to actually assembling the components into the physical product based on the component batch data.

A “digital twin simulation,” as used herein, is a simulation of the virtual representation of a real-world physical asset of a system, such as the components of a composite product, which is continuously updated.

In one embodiment, simulator engine 202 is configured to create and execute a digital twin simulation based on the digital twin (virtual model) generated by representation engine 201 for each representative sample of the components to be assembled into the physical product. In one embodiment, the digital twin (virtual model) is exported for use with automation tools, in order to serve as the model-based test platform for virtual commissioning.

In one embodiment, the digital twin simulation discussed above forms optimization data. “Optimization data,” as used herein, refers to statistical data, assembly data, dimensional data, test data, and/or characteristic data used to quantify the compatibility between the physical component batches. “Compatibility,” as used herein, refers to the ability of the components to be integrated with one another. In one embodiment, such optimization data is stored in database 107.

For example, as the result of the digital twin simulation (optimization data) performed by simulator engine 202, potential defects in assembling components into the physical product are discovered based on analyzing the interconnections involving the integration of such components to form the physical product. Such an analysis may involve range of motion, pressure, thickness of the integrated components, power density, integrated size, integrated weight, integrated power, etc. The result of such an analysis is then compared against a predefined tolerance range to determine if a potential defect has been discovered. As a result, such an analysis involves determining whether any combination of components to be assembled into the physical product has been identified as failing to meet the predetermined tolerance range thereby identifying a potential defect in assembling the physical product. A “tolerance range,” as used herein, refers to the statistical boundaries that represent the range of outcomes for a given process. For example, a tolerance range may correspond to a thickness dimension (e.g., maximum thickness of 0.82 mm and a minimum thickness of 0.75 mm) for the physical product that was assembled based on integrating three separate components to form the physical product. If the thickness of the integrated components exceeded the maximum thickness of 0.82 mm, then a potential defect in assembling the physical product is identified. If, however, the thickness of the integrated components does not exceed the maximum thickness of 0.82 mm and exceeds the minimum thickness of 0.75 mm, then such an integration of the components complies with the requirements for integration. The result of such an analysis corresponds to the optimization data, which is used to quantify the compatibility between the physical component batches.

In one embodiment, such predetermined tolerance ranges are unique for each possible interconnection between the components, such as the combined height, combined thickness, combined power usage, combined density, etc. In one embodiment, such predetermined tolerance ranges are stored in a data structure (e.g., table) of manufacturing process optimizer 102, which may reside within a storage device of manufacturing process optimizer 102. In one embodiment, such a data structure is populated by an expert.

In one embodiment, simulator engine 202 utilizes various software tools for creating and executing such a digital twin simulation forming optimization data, including, but not limited to, Vention®, aPriori® Digital Manufacturing Simulation Software, Autodesk® Digital Twin, XMPro®, Predix®, Mimic® Simulation, Ansys® Twin Builder, 7bridges, Akka®, etc.

Manufacturing process optimizer 102 further includes an alert engine 203 configured to generate an alert, such as to the user of manufacturing process optimizer 102, indicating a potential defect in assembling the physical product in response to identifying a combination of components to be assembled into the physical product that fails to meet a predetermined tolerance range based on the digital twin simulation.

In one embodiment, alert engine 203 displays the generated alert to the user of manufacturing process optimizer 102 on the graphical user interface of manufacturing process optimizer 102. In one embodiment, such a user corresponds to the individual responsible for the manufacturing process of the physical product.

In one embodiment, alert engine 203 transmits the generated alert to a user via electronic means, such as via electronic mail, text message, etc.

In one embodiment, alert engine 203 utilizes various software tools for generating such an alert, such as to the user of manufacturing process optimizer 102, including, but not limited to, Pendo®, Qlik View®, Tableau®, etc.

Furthermore, manufacturing process optimizer 102 includes the ability of allowing a user, such as the user of manufacturing process optimizer 102, to interact with the digital twin simulation.

For example, in one embodiment, manufacturing process optimizer 102 includes a guiding engine 204 configured to enable a user, such as the user of manufacturing process optimizer 102, to interact with the digital representation (digital twin) for each batch of components in the virtual environment, such as the virtual environment of the digital twin simulation, to virtually assemble at least a portion of the digital product representation of the physical product. In one embodiment, such a virtual environment corresponds to a virtual reality or augmented reality environment.

In one embodiment, guiding engine 204 enables a user to make such interactions with the digital representation (digital twin) for each batch of components in the virtual environment, such as the virtual environment of the digital twin simulation, via various software tools, including, but not limited to, Beamo®, MapleSim®, Siemens® NX, Adonis® BPM Suite, Atlas Planning Platform®, etc.

In one embodiment, guiding engine 204 is configured to guide a user through a virtual assembly interaction using component batch data and optimization data from the digital twin simulation to identify a combination(s) of components to be assembled into the physical product with a tolerance outside the predetermined tolerance range. In one embodiment, such guidance is provided in response to generating an alert in identifying a potential defect in assembling the physical product.

For example, such component batch data may include statistical data, assembly data, dimensional data, test data, and/or characteristic data pertaining to the component in question. For instance, such data may include the maximum and minimum length, age, size, shape, construction materials, coating history, information on the contents, test data (e.g., temperature versus time, corrosion damage, mechanical damage, metallurgical properties), operating conditions, integration data (e.g., component A is to be integrated in the left-hand slot of component B), etc. Furthermore, such optimization data may include statistical data, assembly data, dimensional data, test data, and/or characteristic data used to quantify the compatibility between the physical component batches. “Compatibility,” as used herein, refers to the ability of the components to be integrated with one another. Additionally, such optimization data includes the results of the analysis from simulator engine 202.

As previously discussed, simulator engine 202 discovers potential defects in assembling components into the physical product based on analyzing the interconnections involving the integration of such components to form the physical product. Such an analysis may involve range of motion, pressure, thickness of the integrated components, power density, integrated size, integrated weight, integrated power, etc. The result of such an analysis is then compared against a predefined tolerance range to determine if a potential defect has been discovered. A “tolerance range,” as used herein, refers to the statistical boundaries that represent the range of outcomes for a given process. For example, a tolerance range may correspond to a thickness dimension (e.g., maximum thickness of 0.82 mm and a minimum thickness of 0.75 mm) for the physical product that was assembled based on integrating three separate components to form the physical product. If the thickness of the integrated components exceeded the maximum thickness of 0.82 mm, then a potential defect in assembling the physical product is identified. If, however, the thickness of the integrated components does not exceed the maximum thickness of 0.82 mm and exceeds the minimum thickness of 0.75 mm, then such an integration of the components complies with the requirements for integration. The result of such an analysis corresponds to the optimization data, which is used to quantify the compatibility between the physical component batches.

In one embodiment, using such information (result of the analysis from simulator engine 202 which is included in the optimization data) as well as the component batch data (e.g., dimensional data of the component) from simulator engine 202, guiding engine 204 is configured to guide the user to the identified combination(s) of components to be assembled into the physical product with a tolerance outside the predetermined tolerance range. In one embodiment, guiding engine 204 guides the user to the specific location of the assembled physical product where the tolerance is outside the predetermined tolerance range.

In one embodiment, guiding engine 204 guides the user through a virtual assembly interaction using component batch data and optimization data from the digital twin simulation to identify a combination(s) of components to be assembled into the physical product with a tolerance outside the predetermined tolerance range via various software tools, including, but not limited to, Beamo®, MapleSim®, Siemens® NX, Adonis® BPM Suite, Atlas Planning Platform®, etc.

Furthermore, in one embodiment, in connection with guiding the user through the virtual assembly process, such guidance may include providing haptic feedback to the user. For example, in one embodiment, guiding engine 204 provides haptic feedback (e.g., vibration, heat, pressure, etc.) once the user is viewing the combination of the components in the virtual environment that results in a potential defect in assembling the physical product. That is, guiding engine 204 provides haptic feedback once the user is guided to visualize the source of a potential defect in assembling the physical product.

Haptic feedback, as used herein, refers to the use of touch to communicate with users, such as vibration, heat, pressure, etc. For example, guiding engine 204 may generate a vibration of the mobile device held by the user of manufacturing process optimizer 102. For instance, guiding engine 204 may issue a text message to the user's mobile device (e.g., smartphone), which may result in a vibration when the user's mobile device's (e.g., smartphone) notification vibration setting is turned on. In another example, guiding engine 204 may generate vibrotactile feedback on the virtual reality gloves (e.g., Noitom® Hi5 virtual reality glove) worn by the user, such as by providing a range of sensations, from light touch to rough textures. In one embodiment, such vibrotactile feedback is generated on the virtual reality gloves worn by the user by guiding engine 204 issuing instructions to the virtual reality device worn by the user to provide such vibrotactile feedback on the virtual reality gloves. In a further example, guiding engine 204 may generate pressure and vibrational feedback on a haptic vest (e.g., bHaptics® TacSuit X40) worn by the user by issuing instructions to the haptic vest to provide such haptic feedback once the user is guided to the combination(s) of components to be assembled into the physical product with a tolerance outside the predetermined tolerance range. In another example, guiding engine 204 may generate thermoelectric effects on the virtual reality wearable device (e.g., Teslasuit®) worn by the user, which can create temperature-based haptic experiences, once the user is guided to visualize the source of a potential defect in assembling the physical product. In one embodiment, guiding engine 204 manipulates the flow of electric currents between alternating conductors on the virtual reality wearable device (one hot and one cold) so that the user can experience different perceived temperatures.

Additionally, manufacturing process optimizer 102 includes a recommendation engine 205 configured to generate a recommendation for addressing the combination(s) of components to be assembled into the physical product with a tolerance outside the predetermined tolerance range.

In one embodiment, recommendation engine 205 generates a recommendation for addressing the potential defect, such as by utilizing a knowledge corpus stored in database 107. A “knowledge corpus,” as used herein, refers to a collection of data that contains information pertaining to particular defects in assembling physical products and the solutions of such defects. In one embodiment, such a knowledge corpus is stored in database 107.

For example, knowledge in the knowledge corpus may be used to identify a solution to the defect of a welding failure that results from combining component A with part number X1 with component B with part number X2 forming the welding equipment of Fanuc® ARC Mate 0iA resulting in the deviation of the welding torch center point position. The knowledge corpus may indicate that the solution to such a defect is to adjust the welding torch center position. Hence, recommendation engine 205 identifies the solution to the defect of the deviation of the welding torch center point position resulting from combining component A with part number X1 with component B with part number X2 using the knowledge corpus.

In one embodiment, recommendation engine 205 utilizes the k-nearest neighbors algorithm to identify such a solution to a potential defect from the knowledge corpus. In one embodiment, the k-nearest neighbors algorithm works by finding the k nearest neighbors of a given item (e.g., solution to a defect). The neighbors are then used to vote on the rating of the item. The algorithm then uses the average of the votes to predict the rating of the item.

In one embodiment, recommendation engine 205 identifies the solution from the knowledge corpus to a potential defect resulting from combining components to be assembled into the physical product using a machine learning algorithm to build and train a model (machine learning model) to identify solutions from the knowledge corpus to potential defects resulting from combining components to be assembled into the physical product. In one embodiment, such a sample data set is compiled by an expert.

Furthermore, such a sample data set is referred to herein as the “training data,” which is used by the machine learning algorithm to make predictions or decisions as to the appropriate solution from the knowledge corpus to a potential defect resulting from combining components to be assembled into the physical product. The algorithm iteratively makes predictions of identifying the appropriate solution from a knowledge corpus to a potential defect resulting from combining components to be assembled into the physical product until the predictions achieve the desired accuracy as determined by an expert. Examples of such learning algorithms include nearest neighbor, Naïve Bayes, decision trees, linear regression, support vector machines, and neural networks.

Upon recommendation engine 205 identifying such a recommendation, such a recommendation may be provided to a user, such as to a user of manufacturing process optimizer 102. In one embodiment, such a recommendation may be presented on the graphical user interface of manufacturing process optimizer 102. In one embodiment, such a user corresponds to the individual responsible for the manufacturing process of the physical product.

In one embodiment, recommendation engine 205 transmits the recommendation to a user via electronic means, such as via electronic mail, text message, etc.

In one embodiment, recommendation engine 205 utilizes various software tools for providing such a recommendation to the user, such as to the user of manufacturing process optimizer 102, including, but not limited to, Pendo®, Qlik View®, Tableau®, etc.

In this manner, the manufacturing process of a physical product may be optimized using a virtual environment by detecting potential defects and potentially addressing such potential defects prior to assembling the components into the physical product thereby preventing redesigns of the physical product and avoiding supply chain delays.

A further description of these and other features is provided below in connection with the discussion of the method for optimizing the manufacturing process of a physical product using a virtual environment.

Prior to the discussion of the method for optimizing the manufacturing process of a physical product using a virtual environment, a description of the hardware configuration of manufacturing process optimizer 102 (FIG. 1) is provided below in connection with FIG. 5.

Referring now to FIG. 5, in conjunction with FIG. 1, FIG. 5 illustrates an embodiment of the present disclosure of the hardware configuration of manufacturing process optimizer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code (stored in block 501) involved in performing the disclosed methods, such as optimizing the manufacturing process of a physical product using a virtual environment. In addition to block 501, computing environment 500 includes, for example, manufacturing process optimizer 102, wide area network (WAN) 524 (in one embodiment, WAN 524 corresponds to network 103 of FIG. 1), end user device (EUD) 502, remote server 503, public cloud 504, and private cloud 505. In this embodiment, manufacturing process optimizer 102 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

Manufacturing process optimizer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically manufacturing process optimizer 102, to keep the presentation as simple as possible. Manufacturing process optimizer 102 may be located in a cloud, even though it is not shown in a cloud in FIG. 5. On the other hand, manufacturing process optimizer 102 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto manufacturing process optimizer 102 to cause a series of operational steps to be performed by processor set 506 of manufacturing process optimizer 102 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 508 and the other storage media discussed below. The program instructions, and associated data, are accessed by processor set 506 to control and direct performance of the disclosed methods. In computing environment 500, at least some of the instructions for performing the disclosed methods may be stored in block 501 in persistent storage 511.

Communication fabric 509 is the signal conduction paths that allow the various components of manufacturing process optimizer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In manufacturing process optimizer 102, the volatile memory 510 is located in a single package and is internal to manufacturing process optimizer 102, but, alternatively or additionally, the volatile memory may be distributed over multiple packages and/or located externally with respect to manufacturing process optimizer 102.

Persistent Storage 511 is any form of non-volatile storage for computers that is now known or to be developed in the future. The non-volatility of this storage means that the stored data is maintained regardless of whether power is being supplied to manufacturing process optimizer 102 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid-state storage devices. Operating system 512 may take several forms, such as various known proprietary operating systems or open-source Portable Operating System Interface type operating systems that employ a kernel. The code included in block 501 typically includes at least some of the computer code involved in performing the disclosed methods.

Peripheral device set 513 includes the set of peripheral devices of manufacturing process optimizer 102. Data communication connections between the peripheral devices and the other components of manufacturing process optimizer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where manufacturing process optimizer 102 is required to have a large amount of storage (for example, where manufacturing process optimizer 102 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows manufacturing process optimizer 102 to communicate with other computers through WAN 524. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the disclosed methods can typically be downloaded to manufacturing process optimizer 102 from an external computer or external storage device through a network adapter card or network interface included in network module 517.

WAN 524 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates manufacturing process optimizer 102), and may take any of the forms discussed above in connection with manufacturing process optimizer 102. EUD 502 typically receives helpful and useful data from the operations of manufacturing process optimizer 102. For example, in a hypothetical case where manufacturing process optimizer 102 is designed to provide a recommendation to an end user, this recommendation would typically be communicated from network module 517 of manufacturing process optimizer 102 through WAN 524 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to manufacturing process optimizer 102. Remote server 503 may be controlled and used by the same entity that operates manufacturing process optimizer 102. Remote server 503 represents the machine(s) that collect and store helpful and useful data for use by other computers, such as manufacturing process optimizer 102. For example, in a hypothetical case where manufacturing process optimizer 102 is designed and programmed to provide a recommendation based on historical data, then this historical data may be provided to manufacturing process optimizer 102 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 524.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 524 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIGS. 2, 3A-3B and 4A-4B to optimize the manufacturing process of a physical product using a virtual environment. In one embodiment, such components may be implemented in hardware. The functions discussed above performed by such components are not generic computer functions. As a result, manufacturing process optimizer 102 is a particular machine that is the result of implementing specific, non-generic computer functions.

In one embodiment, the functionality of such software components of manufacturing process optimizer 102, including the functionality for optimizing the manufacturing process of a physical product using a virtual environment, may be embodied in an application specific integrated circuit.

As stated above, a manufacturing process uses manufacturing methods, operations scheduling software, machinery, and labor to transform raw material into the finished product, including composite products. A composite product is a product formed from multiple components or parts, often sourced from disparate providers. The components that are assembled into the composite product (or a larger component of the composite product) are frequently shipped to the industrial facility (e.g., factory, manufacturing plant, production plant, etc.) where such a manufacturing process is implemented without compatibility, tolerance or cosmetic quality verification. Compatibility refers to such components being able to be integrated together to form the composite product (or a larger component of the composite product). Tolerance refers to the maximum variance in the dimensions of the components where such components can still be assembled together to form the composite product (or a larger component of the composite product) properly. Cosmetic quality verification refers to verifying that the features of the components have the correct specifications. By not performing such compatibility, tolerance or cosmetic quality verification of the components prior to shipping such components to the industrial facility, such verification is performed on-site at the industrial facility when the physical parts are available. As a result, defects in the assembled product, such as a composite product, may not be noticed until the product is actually assembled, which results in additional costs in redesigning the product as well as causing supply chain delays. For example, the three separate components of an enclosure, a duel in-line memory module (DIMM), and a DIMM slot are assembled to form a cavity of a final product. Each component has the correct dimensions according to the specifications. However, when such components are integrated (assembled) to form a cavity of the final product, a quality problem results in which a pin on the DIMM slot becomes bent. Such a pin on the DIMM slot becomes bent because the thickness of the integrated components is 0.92 mm which exceeds the allotted dimension of 0.82 mm for the cavity. If, however, such defects were detected prior to the assembling of the components into the final product (or a larger component of the final product), then the additional costs in redesigning the product and supply chain delays could potentially be avoided.

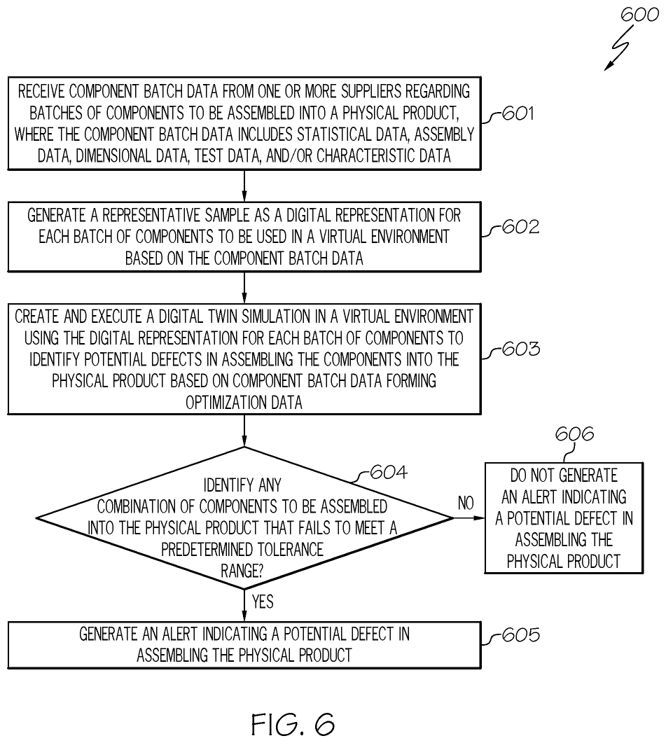

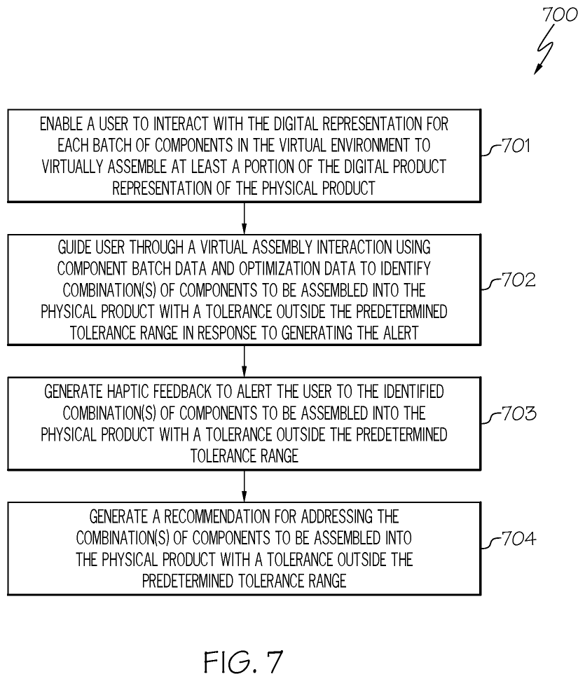

The embodiments of the present disclosure provide a means for detecting defects prior to the assembling of the components into a final product (or a larger component of the final product) using a virtual environment as discussed below in connection with FIGS. 6-7. FIG. 6 is a flowchart of a method for optimizing the manufacturing process of a physical product using a virtual environment. FIG. 7 is a flowchart of a method for allowing a user to interact with the digital twin simulation.

As stated above, FIG. 6 is a flowchart of a method 600 for optimizing the manufacturing process of a physical product using a virtual environment in accordance with an embodiment of the present disclosure.

Referring to FIG. 6, in conjunction with FIGS. 1-2, 3A-3B, 4A-4B and 5, in operation 601, representation engine 201 of manufacturing process optimizer 102 receives component batch data from one or more suppliers regarding the batches of components to be assembled into a physical product.

As stated above, in one embodiment, such component batch data is directly provided to representation engine 201 from server 106 of the supplier(s). Alternatively, such component batch data is provided to representation engine 201 from server 104 of industrial facility 101. Such component batch data is stored in database 107 connected to manufacturing process optimizer 102.

As discussed above, in one embodiment, suppliers provide the components to be assembled into the physical product in batches, such as a group or collection of the components. For example, one supplier may provide a batch of 99 dual in-line memory modules (DIMMs), a second supplier may provide a batch of 99 DIMM slots and a third supplier may provide a batch of 99 enclosures which are together assembled into 99 physical products.

A “batch of components,” as used herein, refers to a collection or group of components. “Component batch data,” as used herein, refers to data pertaining to batches of components, such as statistical data, assembly data, dimensional data, test data, and/or characteristic data. Statistical data, as used herein, refers to the statistical measurements performed on the batch of components, such as the mean, median, or mode of quantitative data (e.g., size, shape, etc.) pertaining to such components. For example, the statistical data may include the mean of the maximum and minimum length. Assembly data, as used herein, refers to the data pertaining to the integration of the components to form the physical product. For example, such assembly data may indicate which part can be integrated into which other parts satisfactorily. For instance, assembly data may indicate that the 100×118 mm ABS® speaker port tube bass reflex tube can be integrated into the Dayton Audio® 2k-HPF-4 high pass speaker crossover. Dimensional data, as used herein, refers to the data pertaining to the features of the components, such as the length, depth, height, width, etc. Test data, as used herein, refers to the data created or selected to satisfy the execution preconditions and inputs to execute one or more test cases. Examples of such test data include temperature versus time, acoustic emission versus time, corrosion damage, mechanical damage, metallurgical properties, etc. Characteristic data, as used herein, refers to features and qualities of the components, such as the operating conditions, construction materials, information on the contents, etc.

An example of the component batch data including dimensional data is illustrated in FIGS. 3A-3B.

As shown in FIG. 3A, FIG. 3A depicts the location of latches 301 to be integrated with a small top cover 302 forming the physical product. As illustrated in FIG. 3B, FIG. 3B is a table 300 indicating the component batch data for the components 302, 301 depicted in FIG. 3A. In one embodiment, such component batch data includes a location 303, a description 304 (e.g., small top cover, latch), a part number 305 (e.g., X1, Y1), a location along the X-axis 306 (e.g., X=10; −10 and X=5; −5), a location along the Y-axis 307 (e.g., Y=0; −10 and Y=0; −5), a location along the Z-axis 308 (e.g., Z=−0.5 and Z=−1) and the degree 309 corresponding to the measurement of the angle formed by component 302, 301 with respect to the center axis (e.g., 270°,290°).

Another example of the component batch data including dimensional data is illustrated in FIGS. 4A-4B.

As shown in FIG. 4A, FIG. 4A depicts the location of latches 401 to be integrated with a small top cover 402 and a top cover 403 forming the physical product. As illustrated in FIG. 4B, FIG. 4B is a table 400 indicating the component batch data for the components 402, 401, 403 depicted in FIG. 4A. In one embodiment, such component batch data includes a location 404, a description 405 (e.g., small top cover, latch, top cover), a part number 406 (e.g., X1, X2, X3), critical to quality (CTQ) dimensions 407 (e.g., width, length), the supplier and the location of the supplier (see element number 408) (e.g., supplier #1 located in China, supplier #2 located in Thailand and supplier #3 located in China) and the average dimension (width) 409 per lot or batch of components for each of the components (parts) (e.g., Lot 1=1.00 and Lot 2=1.05 for Part Number X1; Lot 1=0.980 and Lot 2=0.975 for Part Number X2; and Lot 1=5.00 and Lot 2=5.05 for Part Number X3).

Furthermore, as discussed above, in one embodiment, server 104 of industrial facility 101 receives component batch data from disparate suppliers. In one embodiment, the component batch data is stored in a storage device of server 104. In one embodiment, representation engine 201 receives such stored component batch data from server 104, such as via network 103.

Furthermore, in one embodiment, server 106 of supplier facility 105 stores component batch data pertaining to the batches of components manufactured by supplier facility 105, such as in a storage device of server 106.

In one embodiment, servers 106 of supplier facilities 105 provide the component batch data pertaining to the batch(es) of components to be shipped to industrial facility 101 to be assembled into the physical product directly to representation engine 201, such as via network 103. Such component batch data is stored in database 107 connected to manufacturing process optimizer 102.

In operation 602, representation engine 201 of manufacturing process optimizer 102 generates a representative sample as a digital or virtual representation for each batch of components to be used in the virtual environment based on the component batch data.

As stated above, for example, using statistical data of the component batch data, such as the maximum or minimum length of the components in the batch of components, a representative sample (in the form of a digital or virtual representation) of the entire batch of components may be utilized to represent the entire component batch from the supplier rather than digitizing each component of the batch of components, which is extremely time-consuming. Each representative sample for each batch of components that is to be assembled into the physical product will then be used in the virtual environment to discover any potential defects prior to the assembling of the components into the final product (or a larger component of the final product).

In one embodiment, representation engine 201 creates a digital twin of the representative sample for each batch of components. A “digital twin,” as used herein, is a digital or virtual representation (e.g., virtual model) of a real-world physical asset of a system, such as the component to be used in conjunction with another component(s) to be integrated together to form the physical product. In one embodiment, such a digital twin is created based on the component batch data, which includes statistical data, assembly data, dimensional data, test data, and/or characteristic data. Using such data, such as the maximum and minimum length, age, size, shape, construction materials, coating history, information on the contents, test data (e.g., temperature versus time, corrosion damage, mechanical damage, metallurgical properties), operating conditions, integration data (e.g., component A is to be integrated in the left-hand slot of component B), etc., a digital twin is created with such features.

In one embodiment, representation engine 201 utilizes various software tools for creating and executing such a digital twin, including, but not limited to, Vention®, aPriori® Autodesk® Digital Twin, XMPro®, Predix®, Ansys® Twin Builder, 7bridges, Akka®, Abaqus®, etc.

In operation 603, simulator engine 202 of manufacturing process optimizer 102 creates and executes a digital twin simulation in the virtual environment using the digital or virtual representation for each batch of components to identify potential defects in assembling components into the physical product prior to actually assembling the components into the physical product based on the component batch data.

As discussed above, a “digital twin simulation,” as used herein, is a simulation of the virtual representation of a real-world physical asset of a system, such as the components of a composite product, which is continuously updated.

In one embodiment, simulator engine 202 is configured to create and execute a digital twin simulation based on the digital twin (virtual model) generated by representation engine 201 for each representative sample of the components to be assembled into the physical product. In one embodiment, the digital twin (virtual model) is exported for use with automation tools, in order to serve as the model-based test platform for virtual commissioning.

In one embodiment, the digital twin simulation discussed above forms optimization data. “Optimization data,” as used herein, refers to statistical data, assembly data, dimensional data, test data, and/or characteristic data used to quantify the compatibility between the physical component batches. “Compatibility,” as used herein, refers to the ability of the components to be integrated with one another. In one embodiment, such optimization data is stored in database 107.

For example, as the result of the digital twin simulation (optimization data) performed by simulator engine 202, potential defects in assembling components into the physical product are discovered based on analyzing the interconnections involving the integration of such components to form the physical product. Such an analysis may involve range of motion, pressure, thickness of the integrated components, power density, integrated size, integrated weight, integrated power, etc. The result of such an analysis is then compared against a predefined tolerance range to determine if a potential defect has been discovered. As a result, such an analysis involves determining whether any combination of components to be assembled into the physical product has been identified as failing to meet the predetermined tolerance range thereby identifying a potential defect in assembling the physical product. A “tolerance range,” as used herein, refers to the statistical boundaries that represent the range of outcomes for a given process. For example, a tolerance range may correspond to a thickness dimension (e.g., maximum thickness of 0.82 mm and a minimum thickness of 0.75 mm) for the physical product that was assembled based on integrating three separate components to form the physical product. If the thickness of the integrated components exceeded the maximum thickness of 0.82 mm, then a potential defect in assembling the physical product is identified. If, however, the thickness of the integrated components does not exceed the maximum thickness of 0.82 mm and exceeds the minimum thickness of 0.75 mm, then such an integration of the components complies with the requirements for integration. The result of such an analysis corresponds to the optimization data, which is used to quantify the compatibility between the physical component batches.

In one embodiment, such predetermined tolerance ranges are unique for each possible interconnection between the components, such as the combined height, combined thickness, combined power usage, combined density, etc. In one embodiment, such predetermined tolerance ranges are stored in a data structure (e.g., table) of manufacturing process optimizer 102, which may reside within a storage device (e.g., storage device 511, 515) of manufacturing process optimizer 102. In one embodiment, such a data structure is populated by an expert.

In one embodiment, simulator engine 202 utilizes various software tools for creating and executing such a digital twin simulation forming optimization data, including, but not limited to, Vention®, aPriori® Digital Manufacturing Simulation Software, Autodesk® Digital Twin, XMPro®, Predix®, Mimic® Simulation, Ansys® Twin Builder, 7bridges, Akka®, etc.

In operation 604, simulator engine 202 of manufacturing process optimizer 102 determines whether any combination of components to be assembled into the physical product is identified that fails to meet the predetermined tolerance range.

As discussed above, simulator engine 202 performs an analysis in the digital twin simulation to discover any potential defects in assembling components into the physical product based on analyzing the interconnections involving the integration of such components to form the physical product. Such an analysis involves determining whether any combination of components to be assembled into the physical product has been identified as failing to meet the predetermined tolerance range thereby identifying a potential defect in assembling the physical product.

Upon simulator engine 202 identifying a combination of components to be assembled into the physical product as failing to meet the predetermined tolerance range, in operation 605, alert engine 203 of manufacturing process optimizer 102 generates an alert, such as to the user of manufacturing process optimizer 102, indicating a potential defect in assembling the physical product.

As discussed above, in one embodiment, alert engine 203 displays the generated alert to the user of manufacturing process optimizer 102 on the graphical user interface of manufacturing process optimizer 102. In one embodiment, such a user corresponds to the expert of the manufacturing process of the physical product.

In one embodiment, alert engine 203 transmits the generated alert to a user via electronic means, such as via electronic mail, text message, etc.

In one embodiment, alert engine 203 utilizes various software tools for generating such an alert, such as to the user of manufacturing process optimizer 102, including, but not limited to, Pendo®, Qlik View®, Tableau®, etc.

If, however, simulator engine 202 does not identify a combination of components to be assembled into the physical product as failing to meet the predetermined tolerance range, then, in operation 606, alert engine 203 of manufacturing process optimizer 102 does not generate an alert indicating a potential defect in assembling the physical product.

Furthermore, manufacturing process optimizer 102 includes the ability of allowing a user, such as the user of manufacturing process optimizer 102, to interact with the digital twin simulation as discussed below in connection with FIG. 7.

FIG. 7 is a flowchart of a method 700 for allowing a user to interact with the digital twin simulation in accordance with an embodiment of the present disclosure.

Referring to FIG. 7, in conjunction with FIGS. 1-2, 3A-3B, 4A-4B and 5-6, in operation 701, guiding engine 204 of manufacturing process optimizer 102 enables a user, such as the user of manufacturing process optimizer 102, to interact with the digital representation (digital twin) for each batch of components in the virtual environment, such as the virtual environment of the digital twin simulation, to virtually assemble at least a portion of the digital product representation of the physical product. In one embodiment, such a virtual environment corresponds to a virtual reality or augmented reality environment.

As stated above, in one embodiment, guiding engine 204 enables a user to make such interactions with the digital representation (digital twin) for each batch of components in the virtual environment, such as the virtual environment of the digital twin simulation, via various software tools, including, but not limited to, Beamo®, MapleSim®, Siemens® NX, Adonis® BPM Suite, Atlas Planning Platform®, etc.

In operation 702, guiding engine 204 of manufacturing process optimizer 102 guides a user through a virtual assembly interaction using component batch data and optimization data from the digital twin simulation to identify a combination(s) of components to be assembled into the physical product with a tolerance outside the predetermined tolerance range. In one embodiment, such guidance is provided in response to generating an alert in identifying a potential defect in assembling the physical product.

For example, such component batch data may include statistical data, assembly data, dimensional data, test data, and/or characteristic data pertaining to the component in question. For instance, such data may include the maximum and minimum length, age, size, shape, construction materials, coating history, information on the contents, test data (e.g., temperature versus time, corrosion damage, mechanical damage, metallurgical properties), operating conditions, integration data (e.g., component A is to be integrated in the left-hand slot of component B), etc. Furthermore, such optimization data may include statistical data, assembly data, dimensional data, test data, and/or characteristic data used to quantify the compatibility between the physical component batches. “Compatibility,” as used herein, refers to the ability of the components to be integrated with one another. Additionally, such optimization data includes the results of the analysis from simulator engine 202.

As previously discussed, simulator engine 202 discovers potential defects in assembling components into the physical product based on analyzing the interconnections involving the integration of such components to form the physical product. Such an analysis may involve range of motion, pressure, thickness of the integrated components, power density, integrated size, integrated weight, integrated power, etc. The result of such an analysis is then compared against a predefined tolerance range to determine if a potential defect has been discovered. A “tolerance range,” as used herein, refers to the statistical boundaries that represent the range of outcomes for a given process. For example, a tolerance range may correspond to a thickness dimension (e.g., maximum thickness of 0.82 mm and a minimum thickness of 0.75 mm) for the physical product that was assembled based on integrating three separate components to form the physical product. If the thickness of the integrated components exceeded the maximum thickness of 0.82 mm, then a potential defect in assembling the physical product is identified. If, however, the thickness of the integrated components does not exceed the maximum thickness of 0.82 mm and exceeds the minimum thickness of 0.75 mm, then such an integration of the components complies with the requirements for integration. The result of such an analysis corresponds to the optimization data, which is used to quantify the compatibility between the physical component batches.

In one embodiment, using such information (result of the analysis from simulator engine 202 which is included in the optimization data) as well as the component batch data (e.g., dimensional data of the component) from simulator engine 202, guiding engine 204 is configured to guide the user to the identified combination(s) of components to be assembled into the physical product with a tolerance outside the predetermined tolerance range. In one embodiment, guiding engine 204 guides the user to the specific location of the assembled physical product where the tolerance is outside the predetermined tolerance range.

In one embodiment, guiding engine 204 guides the user through a virtual assembly interaction using component batch data and optimization data from the digital twin simulation to identify a combination(s) of components to be assembled into the physical product with a tolerance outside the predetermined tolerance range via various software tools, including, but not limited to, Beamo®, MapleSim®, Siemens® NX, Adonis® BPM Suite, Atlas Planning Platform®, etc.

In operation 703, guiding engine 204 of manufacturing process optimizer 102 generates haptic feedback to alert the user to a combination(s) of components to be assembled into the physical product with a tolerance outside the predetermined tolerance range.

As discussed above, in one embodiment, in connection with guiding engine 204 guiding the user through the virtual assembly process, such guidance may include providing haptic feedback to the user. For example, in one embodiment, guiding engine 204 provides haptic feedback (e.g., vibration, heat, pressure, etc.) once the user is viewing the combination of the components in the virtual environment that results in a potential defect in assembling the physical product. That is, guiding engine 204 provides haptic feedback once the user is guided to visualize the source of a potential defect in assembling the physical product.

Haptic feedback, as used herein, refers to the use of touch to communicate with users, such as vibration, heat, pressure, etc. For example, guiding engine 204 may generate a vibration of the mobile device held by the user of manufacturing process optimizer 102. For instance, guiding engine 204 may issue a text message to the user's mobile device (e.g., smartphone), which may result in a vibration when the user's mobile device's (e.g., smartphone) notification vibration setting is turned on. In another example, guiding engine 204 may generate vibrotactile feedback on the virtual reality gloves (e.g., Noitom® Hi5 virtual reality glove) worn by the user, such as by providing a range of sensations, from light touch to rough textures. In one embodiment, such vibrotactile feedback is generated on the virtual reality gloves worn by the user by guiding engine 204 issuing instructions to the virtual reality device worn by the user to provide such vibrotactile feedback on the virtual reality gloves. In a further example, guiding engine 204 may generate pressure and vibrational feedback on a haptic vest (e.g., bHaptics® TacSuit X40) worn by the user by issuing instructions to the haptic vest to provide such haptic feedback once the user is guided to the combination(s) of components to be assembled into the physical product with a tolerance outside the predetermined tolerance range. In another example, guiding engine 204 may generate thermoelectric effects on the virtual reality wearable device (e.g., Teslasuit®) worn by the user, which can create temperature-based haptic experiences, once the user is guided to visualize the source of a potential defect in assembling the physical product. In one embodiment, guiding engine 204 manipulates the flow of electric currents between alternating conductors on the virtual reality wearable device (one hot and one cold) so that the user can experience different perceived temperatures.

In operation 704, recommendation engine 205 of manufacturing process optimizer 102 generates a recommendation for addressing the combination(s) of components to be assembled into the physical product with a tolerance outside the predetermined tolerance range.

As stated above, in one embodiment, recommendation engine 205 generates a recommendation for addressing the potential defect, such as by utilizing a knowledge corpus stored in database 107. A “knowledge corpus,” as used herein, refers to a collection of data that contains information pertaining to particular defects in assembling physical products and the solutions of such defects.

For example, knowledge in the knowledge corpus may be used to identify a solution to the defect of a welding failure that results from combining component A with part number X1 with component B with part number X2 forming the welding equipment of Fanuc® ARC Mate 0iA resulting in the deviation of the welding torch center point position. The knowledge corpus may indicate that the solution to such a defect is to adjust the welding torch center position. Hence, recommendation engine 205 identifies the solution to the defect of the deviation of the welding torch center point position resulting from combining component A with part number X1 with component B with part number X2 using the knowledge corpus.

In one embodiment, recommendation engine 205 utilizes the k-nearest neighbors algorithm to identify such a solution to a potential defect from the knowledge corpus. In one embodiment, the k-nearest neighbors algorithm works by finding the k nearest neighbors of a given item (e.g., solution to a defect). The neighbors are then used to vote on the rating of the item. The algorithm then uses the average of the votes to predict the rating of the item.

In one embodiment, recommendation engine 205 identifies the solution from the knowledge corpus to a potential defect resulting from combining components to be assembled into the physical product using a machine learning algorithm to build and train a model (machine learning model) to identify solutions from the knowledge corpus to potential defects resulting from combining components to be assembled into the physical product. In one embodiment, such a sample data set is compiled by an expert.

Furthermore, such a sample data set is referred to herein as the “training data,” which is used by the machine learning algorithm to make predictions or decisions as to the appropriate solution from a knowledge corpus to a potential defect resulting from combining components to be assembled into the physical product. The algorithm iteratively makes predictions of identifying the appropriate solution from a knowledge corpus to a potential defect resulting from combining components to be assembled into the physical product until the predictions achieve the desired accuracy as determined by an expert. Examples of such learning algorithms include nearest neighbor, Naïve Bayes, decision trees, linear regression, support vector machines, and neural networks.

Upon recommendation engine 205 identifying such a recommendation, such a recommendation may be provided to a user, such as to a user of manufacturing process optimizer 102. In one embodiment, such a recommendation may be presented on the graphical user interface of manufacturing process optimizer 102. In one embodiment, such a user corresponds to the individual responsible for the manufacturing process of the physical product.

In one embodiment, recommendation engine 205 transmits the recommendation to a user via electronic means, such as via electronic mail, text message, etc.

In one embodiment, recommendation engine 205 utilizes various software tools for providing such a recommendation to the user, such as to the user of manufacturing process optimizer 102, including, but not limited to, Pendo®, Qlik View®, Tableau®, etc.

As a result of the foregoing, the manufacturing process of a physical product may be optimized using a virtual environment by detecting potential defects and potentially addressing such potential defects prior to assembling the components into the physical product thereby preventing redesigns of the physical product and avoiding supply chain delays.

Furthermore, the principles of the present disclosure improve the technology or technical field involving the manufacturing process. As discussed above, a manufacturing process uses manufacturing methods, operations scheduling software, machinery, and labor to transform raw material into the finished product, including composite products. A composite product is a product formed from multiple components or parts, often sourced from disparate providers. The components that are assembled into the composite product (or a larger component of the composite product) are frequently shipped to the industrial facility (e.g., factory, manufacturing plant, production plant, etc.) where such a manufacturing process is implemented without compatibility, tolerance or cosmetic quality verification. Compatibility refers to such components being able to be integrated together to form the composite product (or a larger component of the composite product). Tolerance refers to the maximum variance in the dimensions of the components where such components can still be assembled together to form the composite product (or a larger component of the composite product) properly. Cosmetic quality verification refers to verifying that the features of the components have the correct specifications. By not performing such compatibility, tolerance or cosmetic quality verification of the components prior to shipping such components to the industrial facility, such verification is performed on-site at the industrial facility when the physical parts are available. As a result, defects in the assembled product, such as a composite product, may not be noticed until the product is actually assembled, which results in additional costs in redesigning the product as well as causing supply chain delays. For example, the three separate components of an enclosure, a duel in-line memory module (DIMM), and a DIMM slot are assembled to form a cavity of a final product. Each component has the correct dimensions according to the specifications. However, when such components are integrated (assembled) to form a cavity of the final product, a quality problem results in which a pin on the DIMM slot becomes bent. Such a pin on the DIMM slot becomes bent because the thickness of the integrated components is 0.92 mm which exceeds the allotted dimension of 0.82 mm for the cavity. If, however, such defects were detected prior to the assembling of the components into the final product (or a larger component of the final product), then the additional costs in redesigning the product and supply chain delays could potentially be avoided.

Embodiments of the present disclosure improve such technology by receiving component batch data for the batches of components to be assembled into the physical product from one or more suppliers. A “batch of components,” as used herein, refers to a collection or group of components. “Component batch data,” as used herein, refers to data pertaining to batches of components, such as statistical data, assembly data, dimensional data, test data, and/or characteristic data. A representative sample as a digital or virtual representation for each batch of components to be used in the virtual environment based on the component batch data is generated. For example, using statistical data of the component batch data, such as the maximum or minimum length of the components in the batch of components, a representative sample (in the form of a digital or virtual representation) of the entire batch of components may be utilized to represent the entire component batch from the supplier rather than digitizing each component of the batch of components, which is extremely time-consuming. A digital twin simulation in the virtual environment using the digital or virtual representation for each batch of components is then created and executed to determine potential defects in assembling components into the physical product prior to actually assembling the components into the physical product based on the component batch data. A “digital twin simulation,” as used herein, is a simulation of the virtual representation of a real-world physical asset of a system, such as the components of a composite product, which is continuously updated. An analysis is performed in the digital twin simulation to discover any potential defects in assembling components into the physical product based on analyzing the interconnections involving the integration of such components to form the physical product. Such an analysis involves determining whether any combination of components to be assembled into the physical product has been identified as failing to meet a predetermined tolerance range thereby identifying a potential defect in assembling the physical product. Upon identifying a combination of components to be assembled into the physical product as failing to meet the predetermined tolerance range, an alert is generated indicating a potential defect in assembling the physical product. In this manner, the manufacturing process of a physical product may be optimized using a virtual environment by detecting potential defects prior to assembling the components into the physical product thereby preventing redesigns of the physical product and avoiding supply chain delays. Furthermore, in this manner, there is an improvement in the technical field involving the manufacturing process.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for optimizing a manufacturing process of a physical product using a virtual environment, the method comprising:
receiving component batch data regarding batches of components to be assembled into said physical product;
generating a representative sample as a digital representation for each batch of components to be used in said virtual environment based on said component batch data;
creating and executing a digital twin simulation in said virtual environment using said digital representation for each batch of components; and
generating an alert indicating a potential defect in assembling said physical product in response to identifying a combination of components to be assembled into said physical product that fails to meet a predetermined tolerance range based on said digital twin simulation.

2. The computer-implemented method as recited in claim 1, wherein said component batch data comprises statistical data, assembly data, dimensional data, test data, and/or characteristic data.

3. The computer-implemented method as recited in claim 1, wherein said digital twin simulation forms optimization data, wherein said optimization data comprises data used to quantify compatibility between said batches of components.

4. The computer-implemented method as recited in claim 3 further comprising:
enabling a user to interact with said digital representation for each batch of components in said virtual environment to virtually assemble at least a portion of a digital product representation of said physical product.

5. The computer-implemented method as recited in claim 4 further comprising:
guiding said user through a virtual assembly interaction using said component batch data and said optimization data to identify one or more combinations of components to be assembled into said physical product with a tolerance outside said predetermined tolerance range.

6. The computer-implemented method as recited in claim 5 further comprising:
generating haptic feedback to alert said user to said one or more combinations of components to be assembled into said physical product with said tolerance outside said predetermined tolerance range.

7. The computer-implemented method as recited in claim 6 further comprising:
generating a recommendation for addressing said one or more combinations of components to be assembled into said physical product with said tolerance outside said predetermined tolerance range.

8. A computer program product for optimizing a manufacturing process of a physical product using a virtual environment, the computer program product comprising one or more computer readable storage mediums having program code embodied therewith, the program code comprising programming instructions for:
receiving component batch data regarding batches of components to be assembled into said physical product;
generating a representative sample as a digital representation for each batch of components to be used in said virtual environment based on said component batch data;
creating and executing a digital twin simulation in said virtual environment using said digital representation for each batch of components; and
generating an alert indicating a potential defect in assembling said physical product in response to identifying a combination of components to be assembled into said physical product that fails to meet a predetermined tolerance range based on said digital twin simulation.

9. The computer program product as recited in claim 8, wherein said component batch data comprises statistical data, assembly data, dimensional data, test data, and/or characteristic data.

10. The computer program product as recited in claim 8, wherein said digital twin simulation forms optimization data, wherein said optimization data comprises data used to quantify compatibility between said batches of components.

11. The computer program product as recited in claim 10, wherein the program code further comprises the programming instructions for:
enabling a user to interact with said digital representation for each batch of components in said virtual environment to virtually assemble at least a portion of a digital product representation of said physical product.

12. The computer program product as recited in claim 11, wherein the program code further comprises the programming instructions for:
guiding said user through a virtual assembly interaction using said component batch data and said optimization data to identify one or more combinations of components to be assembled into said physical product with a tolerance outside said predetermined tolerance range.

13. The computer program product as recited in claim 12, wherein the program code further comprises the programming instructions for:
generating haptic feedback to alert said user to said one or more combinations of components to be assembled into said physical product with said tolerance outside said predetermined tolerance range.

14. The computer program product as recited in claim 13, wherein the program code further comprises the programming instructions for:
generating a recommendation for addressing said one or more combinations of components to be assembled into said physical product with said tolerance outside said predetermined tolerance range.

15. A system, comprising:
a memory for storing a computer program for optimizing a manufacturing process of a physical product using a virtual environment; and
a processor connected to the memory, wherein the processor is configured to execute program instructions of the computer program comprising:
receiving component batch data regarding batches of components to be assembled into said physical product;
generating a representative sample as a digital representation for each batch of components to be used in said virtual environment based on said component batch data;
creating and executing a digital twin simulation in said virtual environment using said digital representation for each batch of components; and
generating an alert indicating a potential defect in assembling said physical product in response to identifying a combination of components to be assembled into said physical product that fails to meet a predetermined tolerance range based on said digital twin simulation.

16. The system as recited in claim 15, wherein said component batch data comprises statistical data, assembly data, dimensional data, test data, and/or characteristic data.

17. The system as recited in claim 15, wherein said digital twin simulation forms optimization data, wherein said optimization data comprises data used to quantify compatibility between said batches of components.

18. The system as recited in claim 17, wherein the program instructions of the computer program further comprise:
enabling a user to interact with said digital representation for each batch of components in said virtual environment to virtually assemble at least a portion of a digital product representation of said physical product.

19. The system as recited in claim 18, wherein the program instructions of the computer program further comprise:
guiding said user through a virtual assembly interaction using said component batch data and said optimization data to identify one or more combinations of components to be assembled into said physical product with a tolerance outside said predetermined tolerance range.

20. The system as recited in claim 19, wherein the program instructions of the computer program further comprise:
generating haptic feedback to alert said user to said one or more combinations of components to be assembled into said physical product with said tolerance outside said predetermined tolerance range.
